(19) United States
(12) Patent Application Publication
(10) Pub. No.: US 2026/0317638 A1
(43) Pub. Date: Oct. 15, 2026

(54) H2S STRIPPING TOWER

(71) Applicant: WIJG Development, LLC, Lewes, DE (US)

(72) Inventors: Sirlance Nolasco, San Antonio, TX (US); Joseph Lanham, Tomball, TX (US); Floyd Hammond, Rogers, AR (US)

(21) Appl. No.: 19/646,904

(22) Filed: Apr. 14, 2026

Related U.S. Application Data
(60) Provisional application No. 63/788,634, filed on Apr. 14, 2025.
(60) Provisional application No. 63/866,056, filed on Aug. 18, 2025.

(51) Int. Cl. C10G 21/14

(52) U.S. Cl. CPC C10G 21/14; C10G 2300/1033; C10G 2300/207

(57) ABSTRACT

A stripping tower has an injection port for injecting sweet gas into the stripping tower. Crude oil flows over a plurality of vertically spaced apart trays having gas-liquid contact devices thereon. A downcomer extends downwardly a first depth from each tray. An extended downcomer is positioned below a lowermost tray of the vertically spaced apart trays, and extends downward a second depth that is greater than the first depth. A seal pad that reverses the direction of flow of the crude oil from a downward direction to an upward direction is positioned beneath the extended downcomer.

### CROSS REFERENCE TO RELATED APPLICATIONS

The present application claims priority to U.S. Provisional Application No. 63/788,634 filed on Apr. 14, 2025, and U.S. Provisional Application No. 63/866,056 filed on Aug. 18, 2025, which are incorporated herein by reference.

### FIELD

The field relates to systems for removing hydrogen sulfide (H₂S) from crude oil in the oil stabilization process.

### BACKGROUND

Hydrogen sulfide (H₂S) is a hazardous component in crude oil that typically must be removed before transportation and refining. Conventional stripping towers often fail to fully optimize the gas-liquid interaction, leading to incomplete H₂S removal and operational inefficiencies.

Current stripping towers typically rely on standard bubble cap trays, sieve trays, or random packing, which lack design features for managing residence time, vapor re-entrainment, and final polish separation. Without extended downcomers, submerged seal pads, and mist elimination, conventional systems suffer from uneven flow distribution, excessive sweet gas consumption, and incomplete H₂S removal. These limitations result in higher operational costs and reduced treatment efficiency, especially at large crude oil throughput rates.

### BRIEF DESCRIPTION OF THE DRAWINGS

FIG. 1 is a left side view of a stripping tower.

FIG. 2 is a front view of a stripping tower.

FIG. 3 is a right side view of a stripping tower.

FIG. 4 is a top view of a stripping tower.

FIG. 5 is a view of the inside of the stripping tower.

FIG. 6A is a top view of a tray in a first section of the tower.

FIG. 6B is a front view of the tray of FIG. 6A in the first section of the tower.

FIG. 7A is a top view of an additional tray in the first section of the tower.

FIG. 7B is front view of the tray of FIG. 7A.

FIG. 8 is a perspective view of a portion of a tray in the first section of the tower.

FIG. 9 is a perspective view of multiple trays in the first section of the tower.

FIG. 10 is an elevation view of trays in the first section.

FIG. 11 is a view showing the inlet pipe of the tower.

FIG. 12 is a top view of a tray in a second section of the tower.

FIG. 13 is a top view of an additional tray in the second section of the tower.

FIG. 14 is a top view of a tray in a third section of the tower.

FIG. 15 is a top view of an additional tray in a third section of the tower.

FIG. 16 is a view of multiple trays in the tower.

FIG. 17 is a view inside the tower of the fourth section of the tower.

FIG. 18 is a view of the extended downcomers.

FIG. 19 is a view of support rings and bolting bars for the embodiment of FIG. 1.

FIG. 20 is a view of additional support rings and bolting bars for the embodiment of FIG. 1.

FIG. 21 is a view of support rings and bolting bars for an additional embodiment of a stripping tower.

FIG. 22 is a view of a vortex breaker used with the tower.

FIG. 23 is a cross section of a bubble cap.

FIG. 24 is a view of a baffle for a gas inlet of the tower.

FIG. 25 is a view looking at the inside of an additional embodiment of a stripping tower.

FIG. 26 is an orthogonal view of a tray in an upper section of the tower of FIG. 25.

FIG. 27 is a top view of a tray used in the third section of the tower of FIG. 25.

FIG. 28 is an orthogonal view of a tray used in a second section of the tower of FIG. 25.

FIG. 29 is a view of a portion of the fourth section of the tower of FIG. 25.

FIG. 30 is a graph of efficiencies achieved under various conditions.

### DETAILED DESCRIPTION

In the following descriptions and drawings, identical components are labeled with the same reference numerals throughout. Certain elements may be shown in schematic form for clarity, and variations in specific embodiments may be made without deviating from the scope of the invention.

Unless otherwise specified, terms such as “upstream,” “downstream,” “upper,” “lower,” “horizontal,” and “vertical” refer to relative positions within the tower and are not intended to impose strict geometric orientations.

Unless otherwise specified, use of the terms “connect,” “engage,” “couple,” “attach,” or any other like term describing an interaction between elements is not meant to limit the interaction to direct interaction between the elements and may also include indirect interaction between the elements described.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

Further, use of the term “plurality” is meant to convey “more than one” unless expressly stated to the contrary. The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

The system for degassing disclosed herein includes a multi-stage stripping tower 10 with optimized tray configurations, enhanced downcomers, and a controlled sweet gas injection system to improve separation efficiency in the degassing process. In one embodiment, the system is a system for removing H₂S from a liquid, which in the described implementation is crude oil. Although oil is the disclosed liquid being treated by the system, it is understood that the system disclosed may be used to degas other liquids. Stripping tower 10 improves upon existing designs by incorporating specific tray arrangements that transition from high cap density trays for initial gas stripping to reduced cap density trays for additional degassing, along with an extended downcomer and seal pad section and a controlled sweet gas injection system to improve separation efficiency and to maximize H₂S removal. Stripping tower 10 allows for easy implementation by being skid mounted to allow for easy placement and removal of the stripping tower 10. This also allows for modularity to add multiple stripping towers in parallel for larger volumes of oil to be stripped of H₂S while staying at low sweet gas injection rates per barrel of oil.

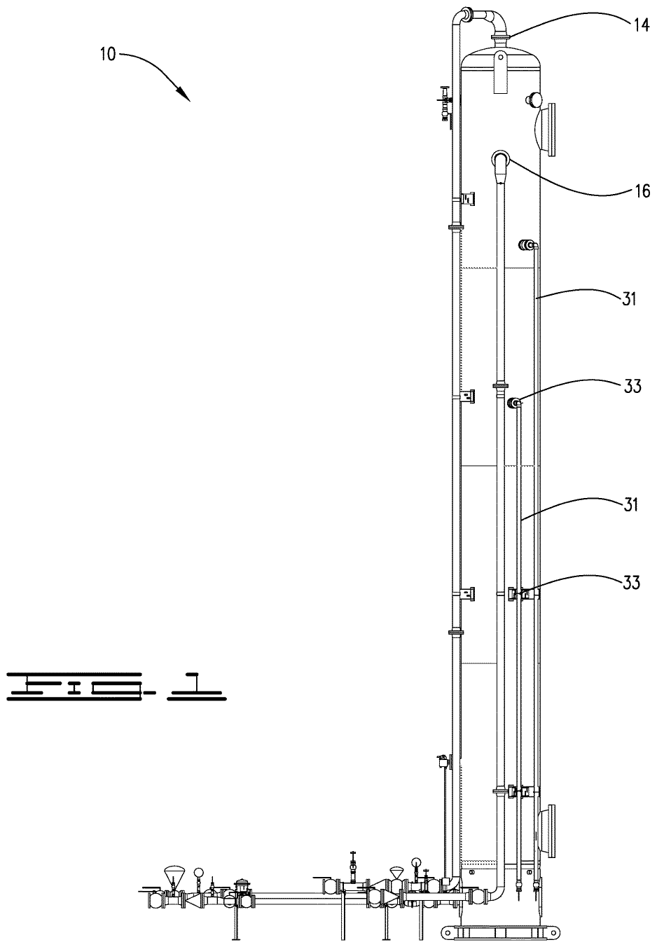

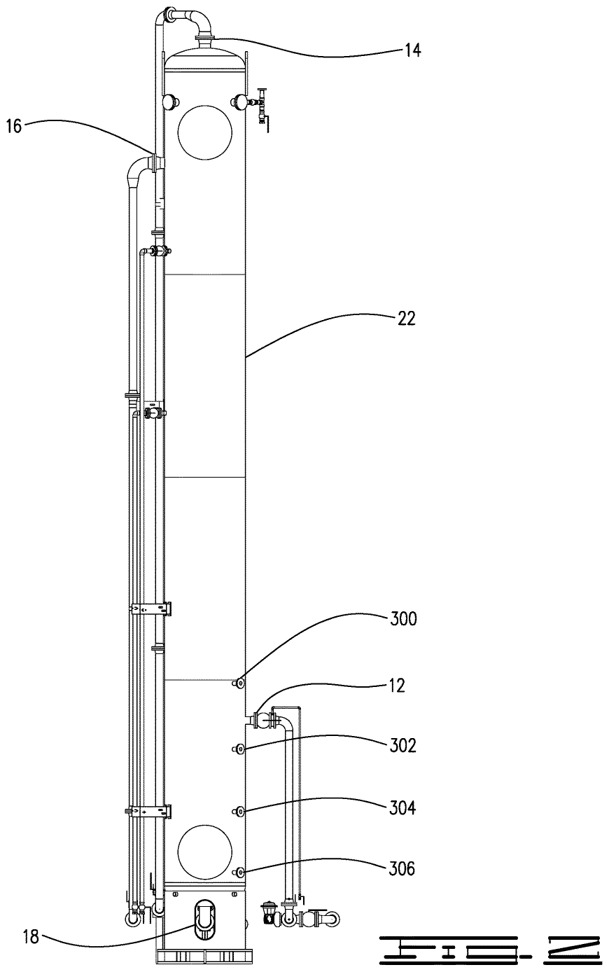

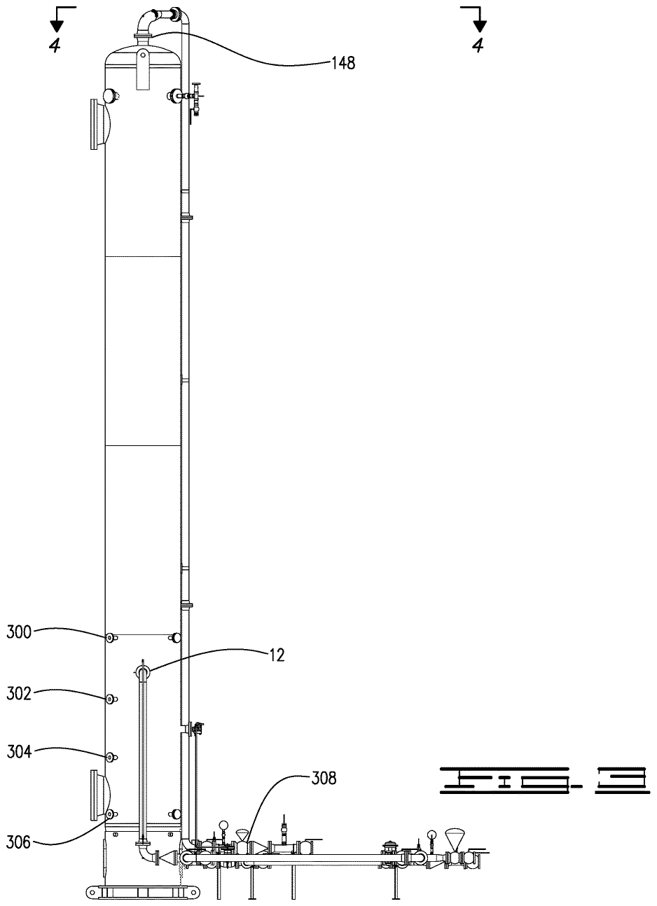

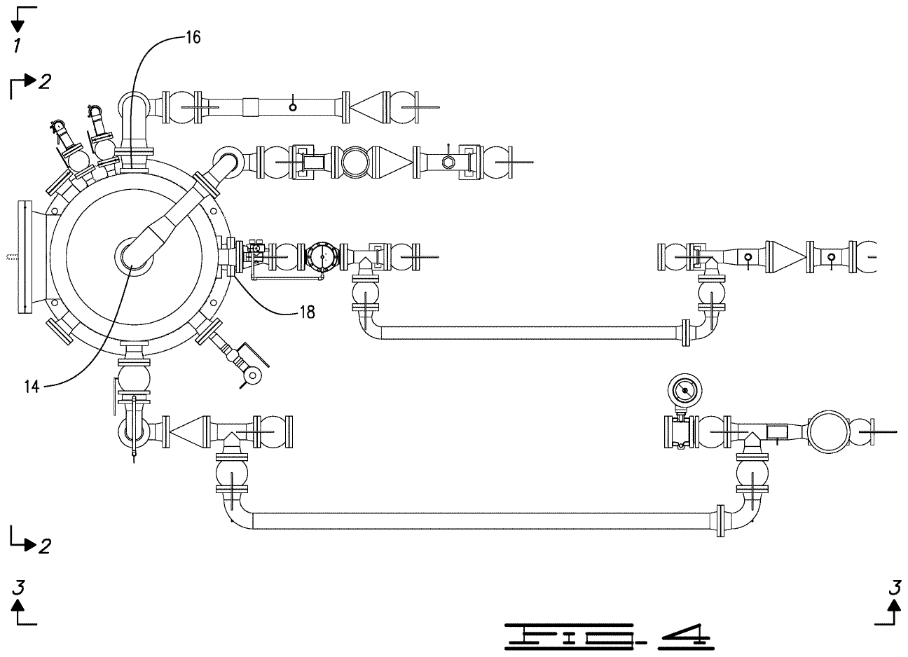

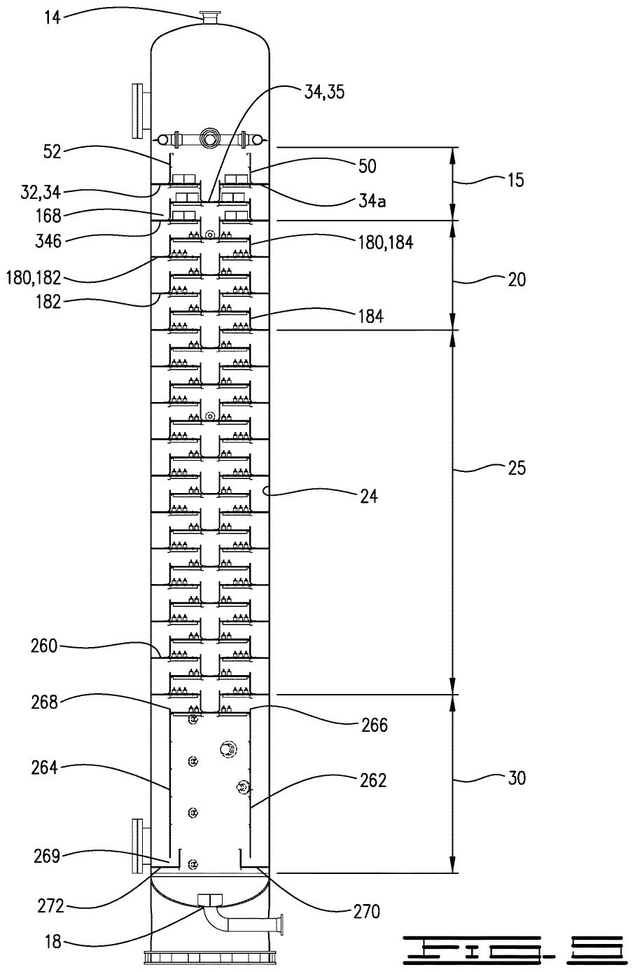

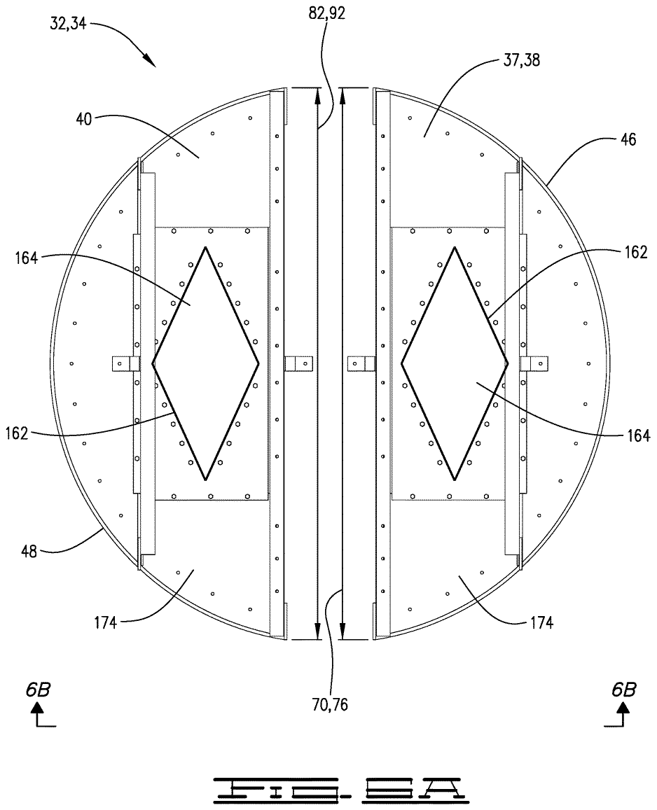

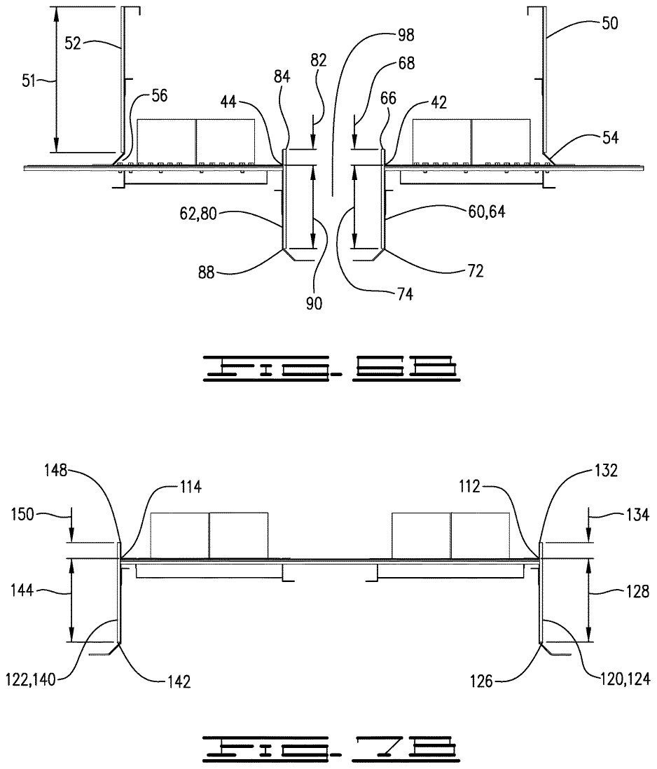

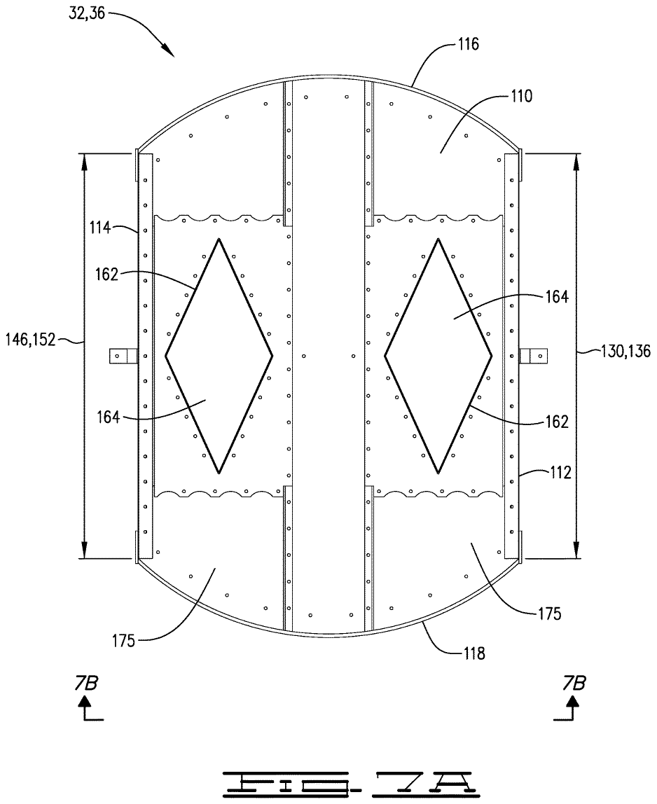

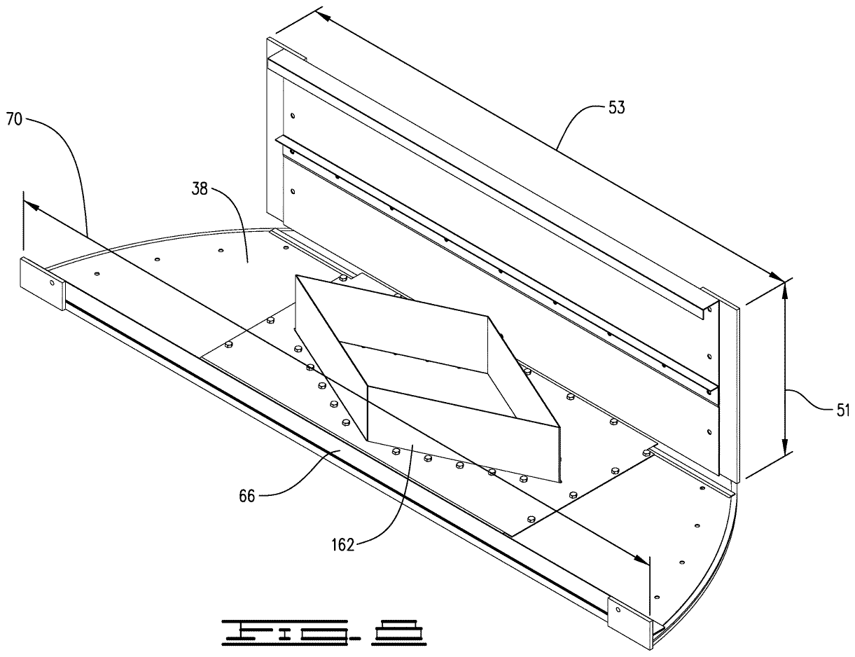

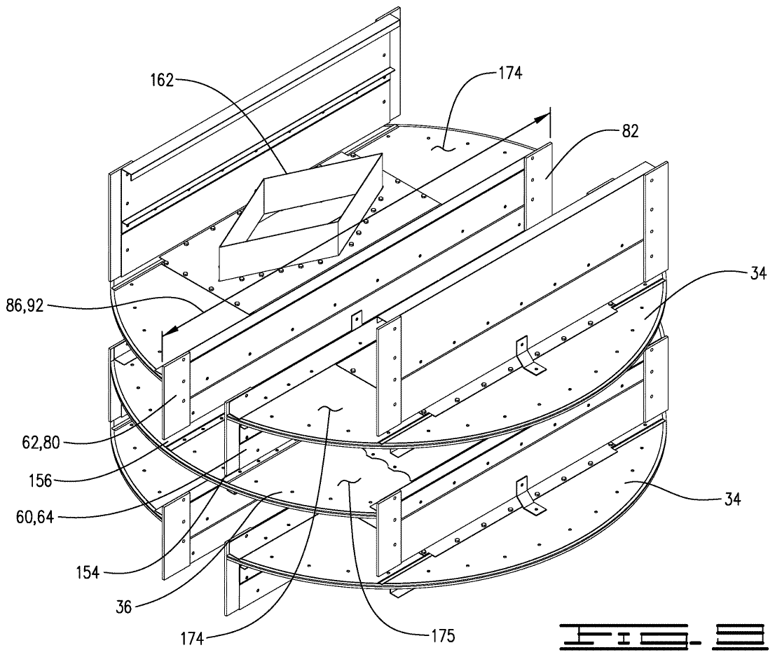

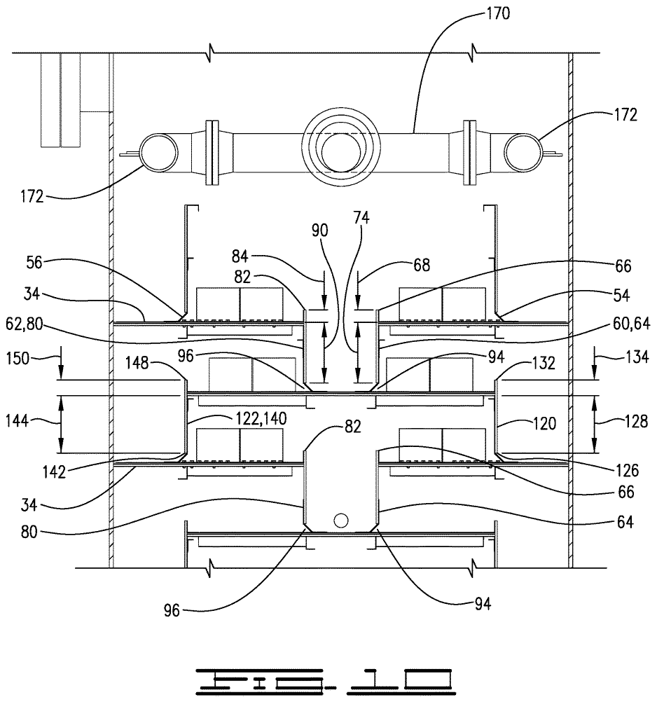

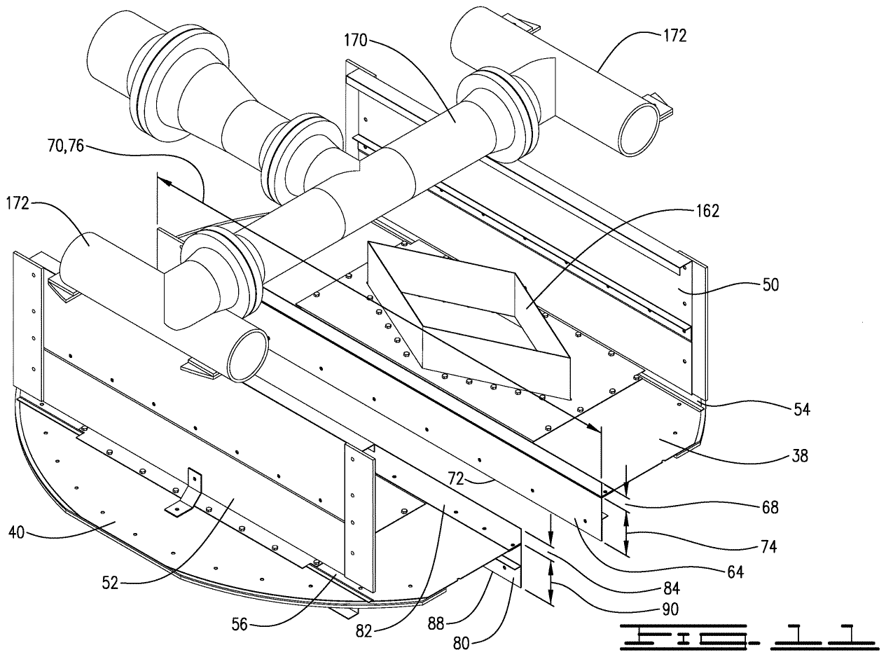

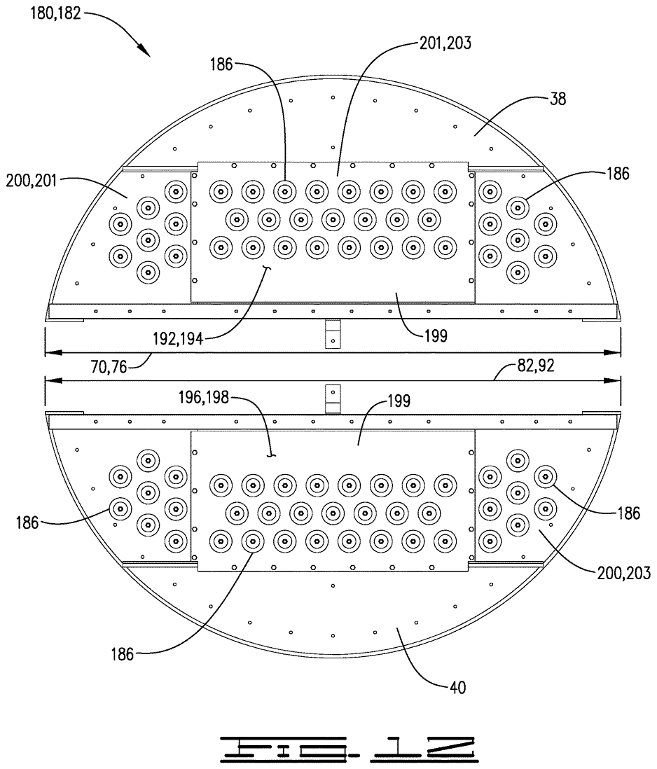

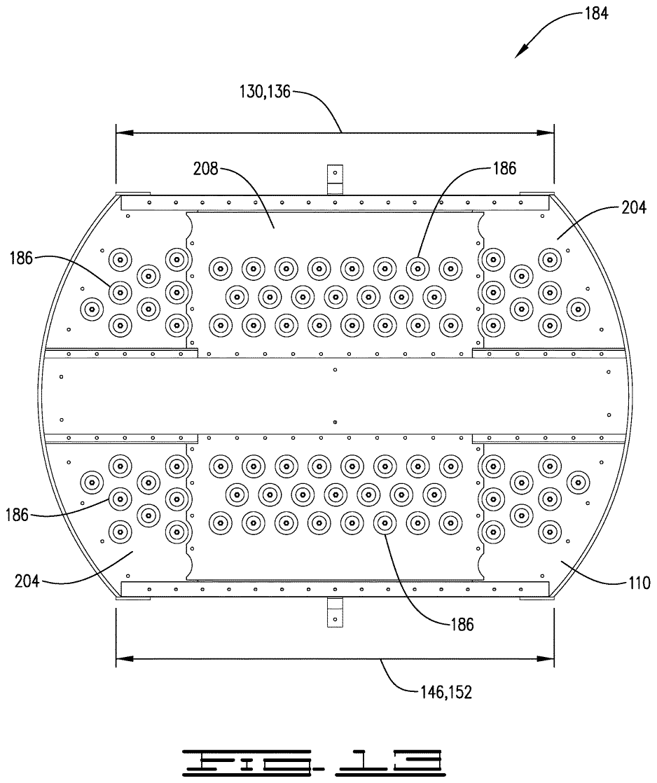

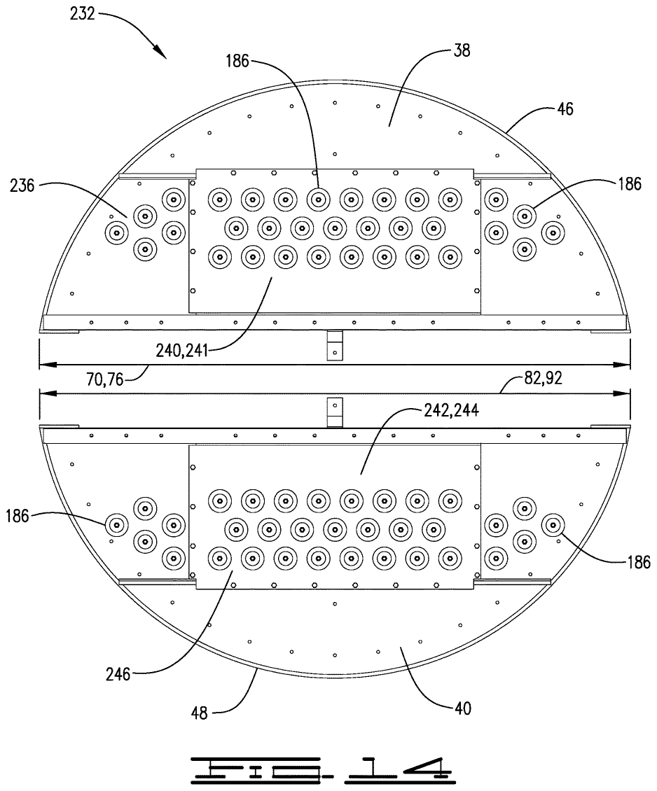

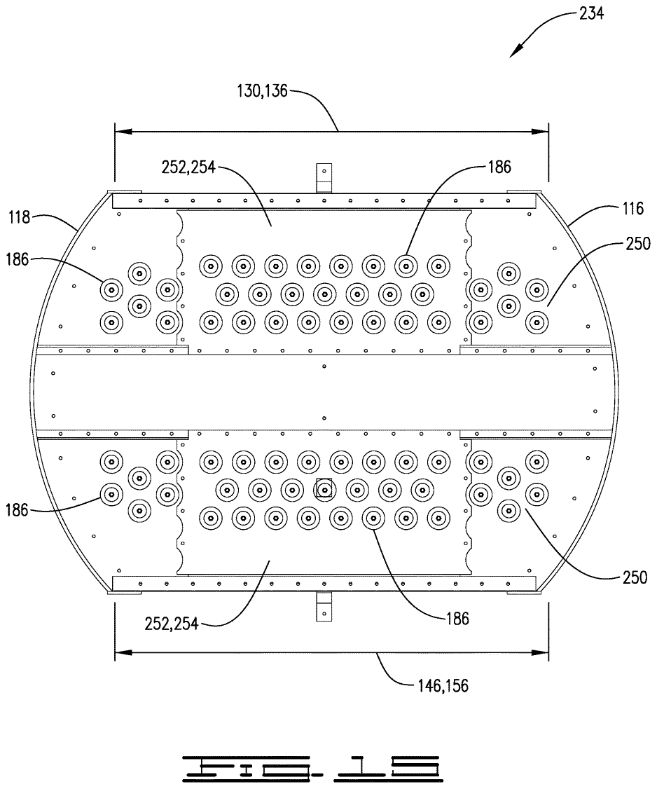

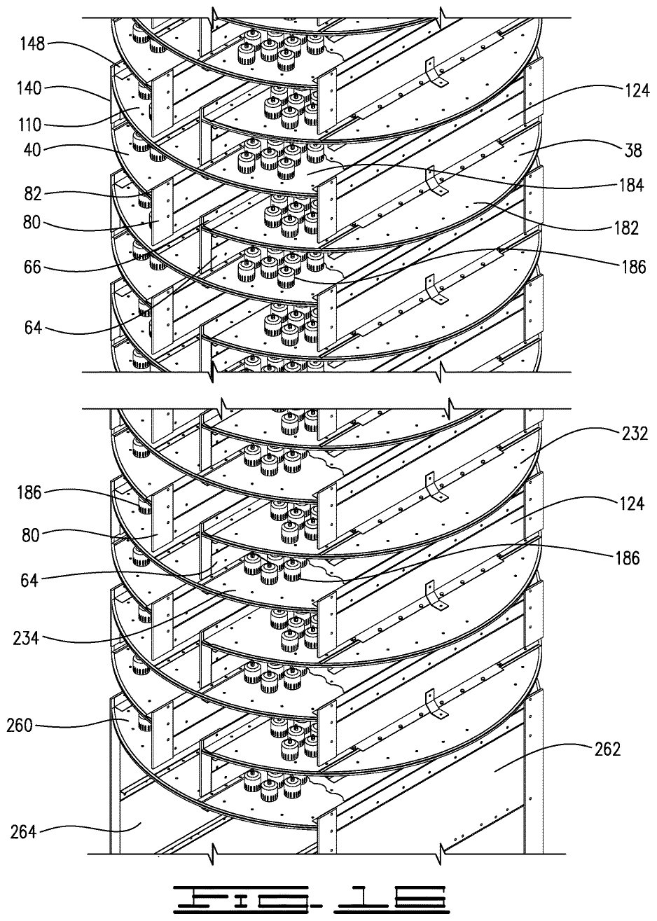

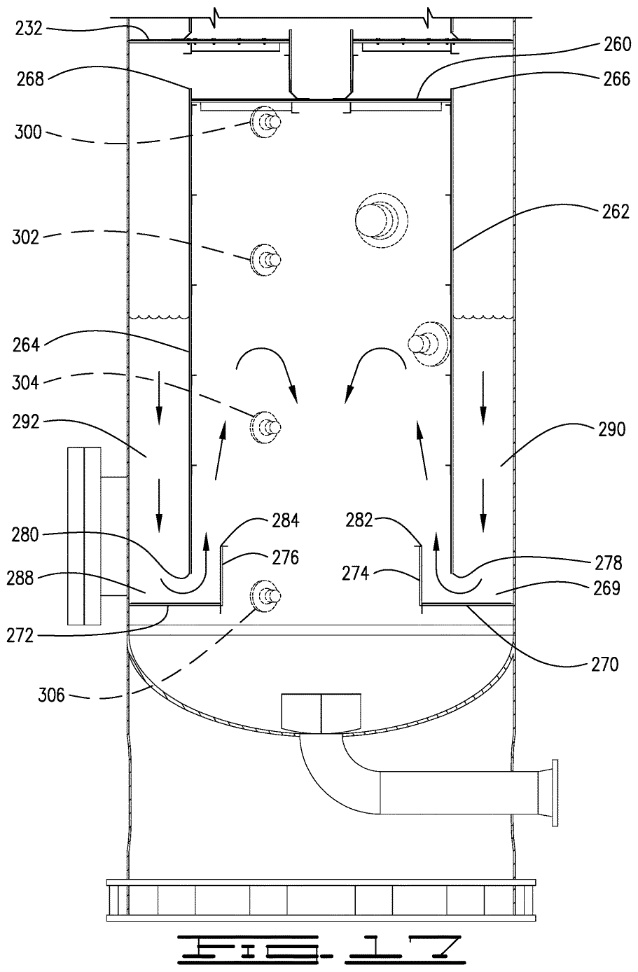

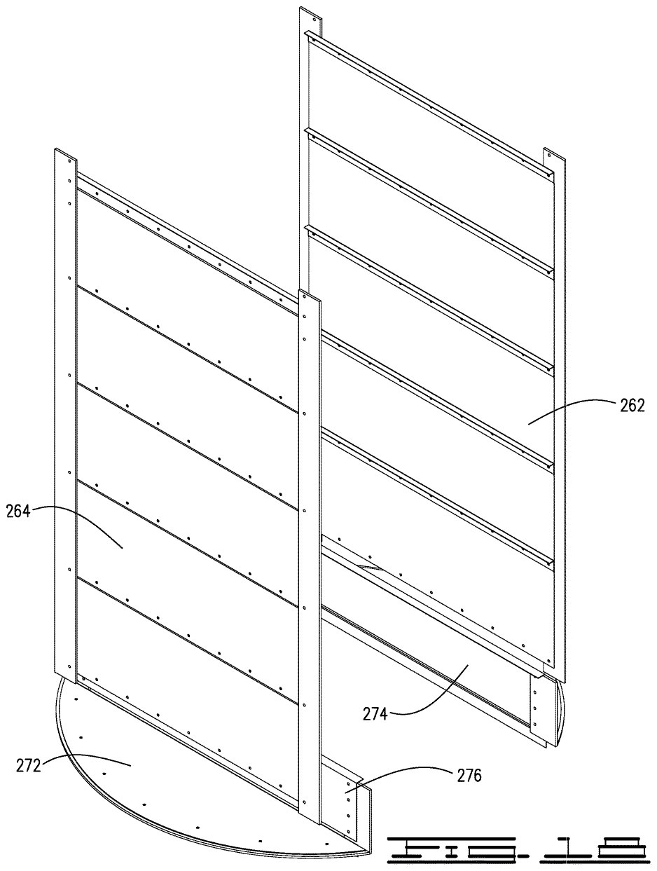

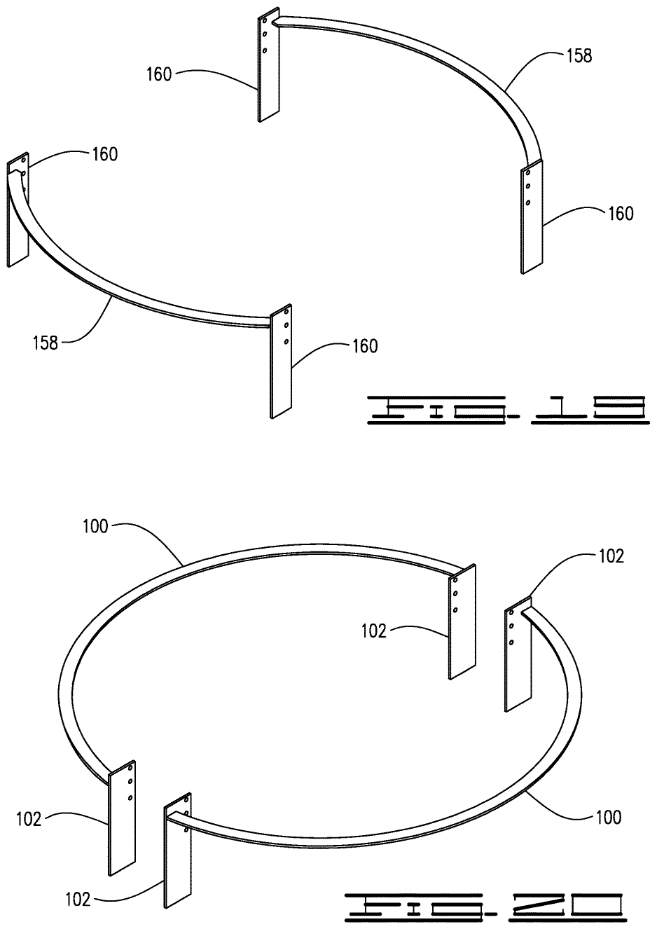

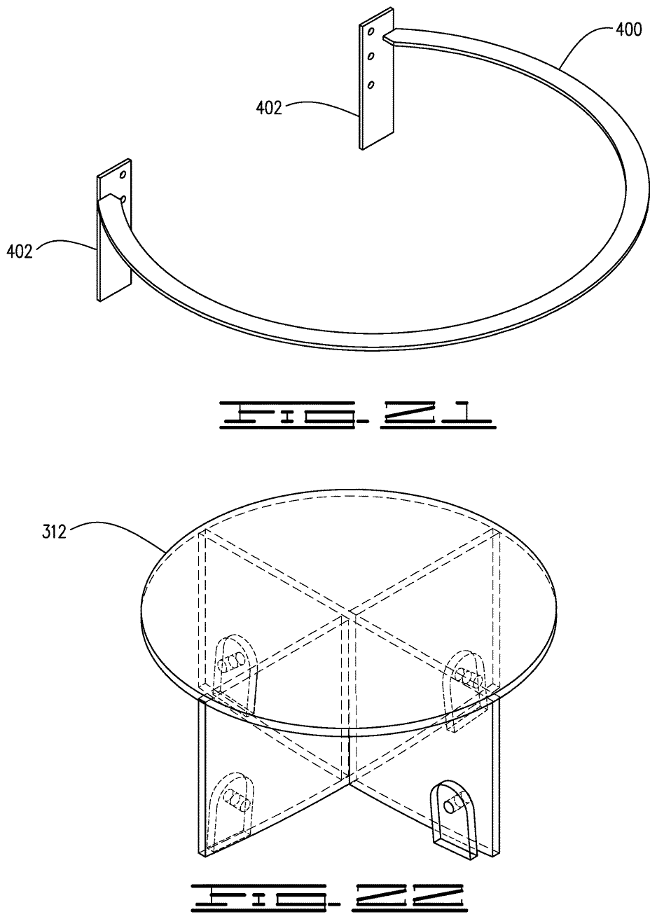

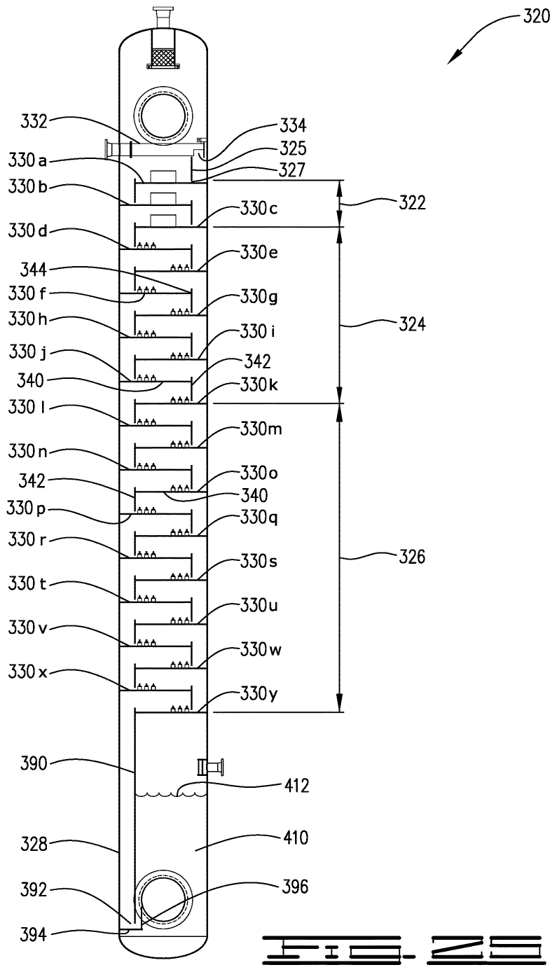

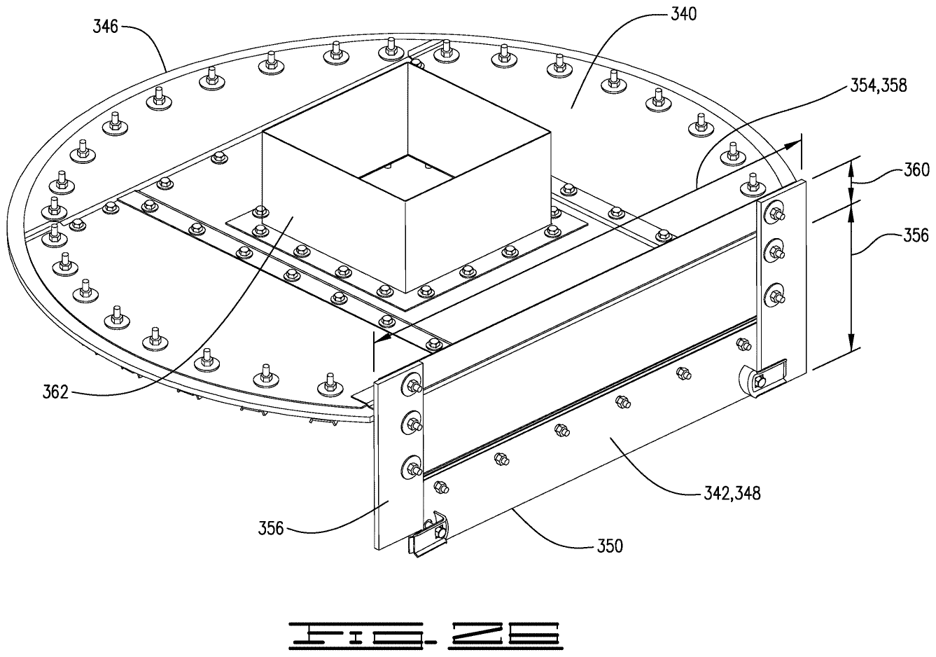

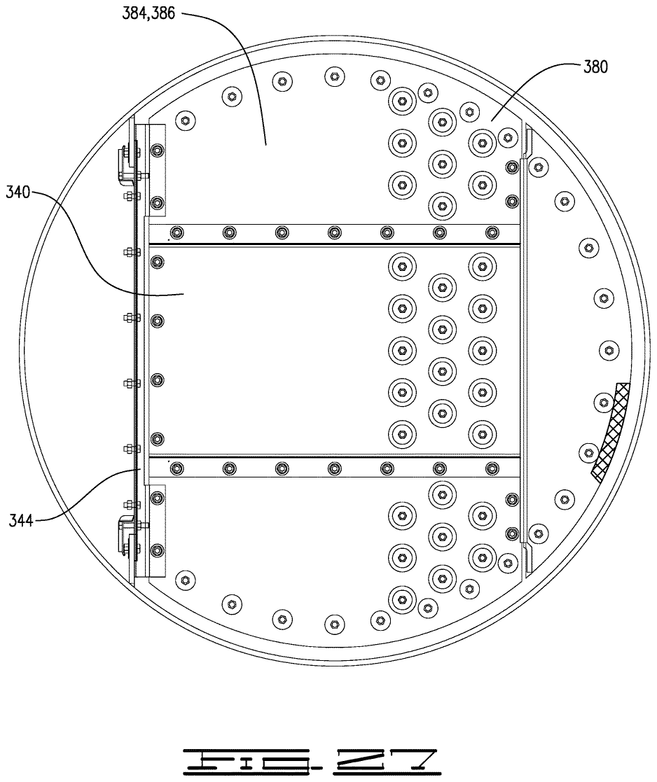

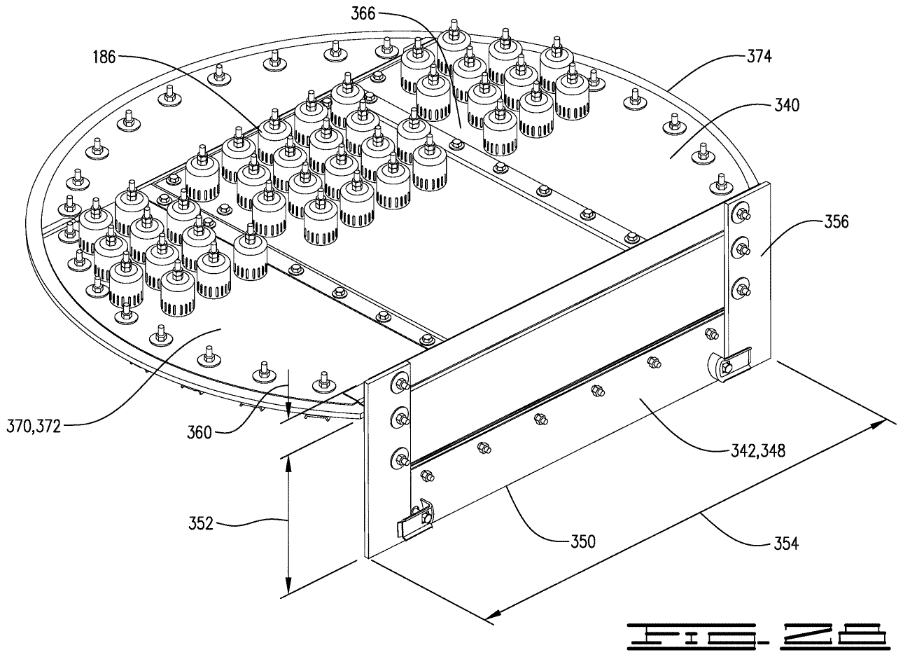

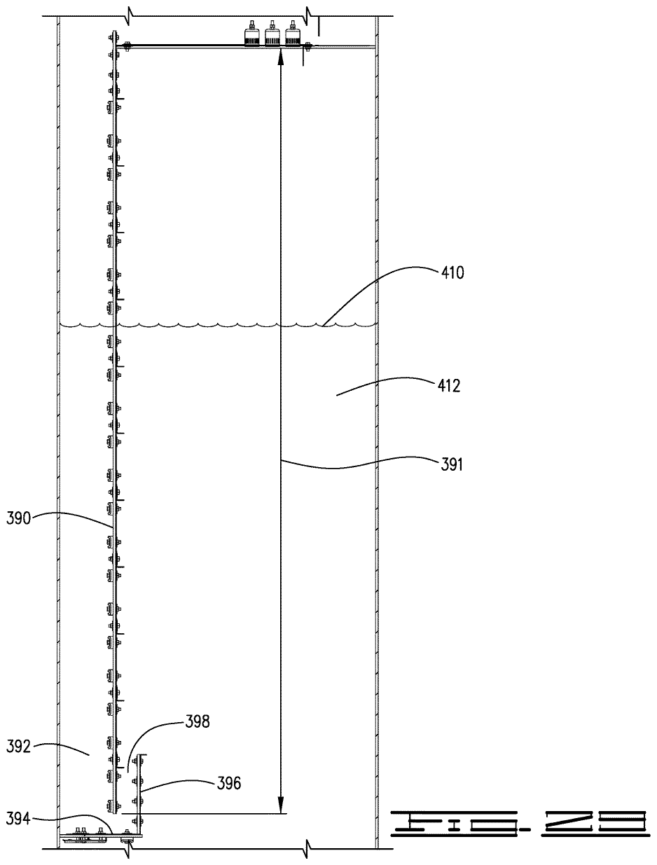

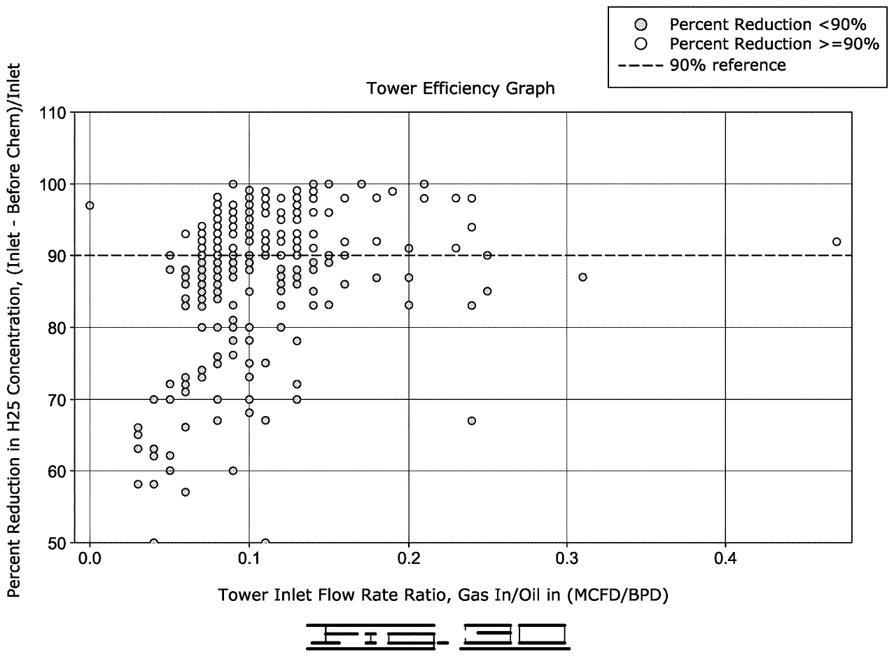

Stripping tower 10 is a structured stripping system that has a sweet gas inlet 12, a sour gas outlet 14, a liquid, or crude oil inlet 16 and an oil outlet 18. Stripping tower 10 consists of four major sections, including a first, or flat tray section 15, a second, or high density bubble cap tray section 20, a third, or reduced density bubble cap section 25 and a fourth, or extended downcomer and seal pad section 30. Each of the sections 15, 20, 25 and 30 contribute to degassing by providing residence time, controlled gas-liquid interaction, and re-entrainment prevention. The system of degassing includes a controlled sweet natural gas injection range of 0.01-0.08 MCF/BO to enhance stripping efficiency. Flow rates for gas can be calculated with models, for example HySys, using real gas analysis and liquid analysis data. The graph in FIG. 30 is real data that can be used to train a HYSYS model, and shows the efficiencies achieved under various conditions. Sweet gas as used herein means a gas with little or no H₂S or other sulfur compounds. Stripping tower 10 in one embodiment is a skid mounted stripping tower and as such enables multiple stripping towers to be placed easily to accommodate for changes in flow rate of fluid, for example oil, to keep the sweet gas injection rate to a minimum per barrel of oil. Sweet gas will be injected through a conduit into inlet 12 at or near a bottom of the stripping tower 10 and will be released though outlet 14 at a top of the stripping tower 10. In one arrangement, gas inlet 12 is positioned in fourth section 30. Stripping tower 10 has a tower shell 22 with an interior surface 24. The exiting gas with H₂S entrained therein will be passed on for further processing to a vapor recovery unit, flare, or other gas treatment system or processing system. Stripping tower 10 may comprise a double pass power, as shown in FIGS. 1-24 or a single pass tower 300 as shown in FIGS. 25-29. A plurality of service lines 31 are communicated with an interior of the stripping tower 10 through valves 33. For towers where high solids or a high chance of two liquid phases exists, cleanout ports where different stages can be accessed with tools and a vacuum truck hose to clean the stages out. Service lines 31 may be used to inject chemicals or other materials into the tower for cleaning or other purposes and may also be used to allow fluid and/or debris to be pushed out of the interior of the tower. Valves 33 are normally closed so that there is no communication into service lines 31 during operation of the stripping tower 10.

First section 15 of the stripping tower 10 comprises trays 32, which may comprise a first configuration 34 and a second configuration 36. First section 15 is an inlet distribution and initial degassing section of the stripping tower 10 and has an inlet distribution assembly configured to stabilize incoming crude oil and promote initial degassing. First configuration 34 comprises a flat plate 37, or deck 37. Tray configuration 34 comprises a split tray with tray decks 38 and 40. Tray decks 38 and 40 are generally identical and include opposed straight edges 42 and 44 respectively, and curved portions 46 and 48 respectively. Tray 34 is essentially a circle with a section cut from the middle thereof. Tray stages alternate between tray configurations in the stripping tower 10. Stripping tower 10 has a total of thirty stages, but it is understood that more or less stages can be used. The described embodiment with thirty stages may be designed for a known liquid flow rate, and flow rates for gas can be calculated with models, for example HySys, using real gas analysis and liquid analysis data. False downcomers 50 and 52 extend upwardly from the tray decks 38 and 40 of the uppermost tray, which may be referred to as tray, or stage 34a. False downcomers may be connected to the shell 22, and may have a depth 51 and a width 53. The configuration of false downcomers 50 and 52 determines the surface area of gas-liquid interface for the liquid entering the first section 15. By maximizing the gas liquid interface, the efficiency of the tower is increased In one implementation, the width 53 of downcomers 50 and 52 may be greater than the depth 51 and may be for example at least about 1.0-2.0 times, and in one implementation at least about 1.5 times the depth which provides a maximized gas liquid interface. Gaps 54 and 56 are defined between false downcomers 50 and 52 and the tray decks 38 and 40 of tray 34a respectively and allow liquid to flow thereunder.

Tray, or stage 34, has vertical plates 60 and 62 attached to the inner edges 42 and 44 of tray decks 38 and 40 respectively. Vertical plates 60 and 62 define opposed internal downcomers 64 and 80 and opposed weirs 66 and 82. Vertical plate 60 defines a downcomer 64 extending downward from tray deck 38 and a weir 66 extending upwardly therefrom. Weir 66 has a height 68 and a length 70. Downcomer 64 has a lower edge 72. Downcomer 64 has a depth 74 and a width 76, which is the same as length 70. Vertical plate 62 defines a downcomer 80 extending downward from tray deck 40 and a weir 82 extending upwardly therefrom. Weir 82 has a height 84 which is the same as height 68 and has a length 86. Downcomer 80 has a lower edge 88 and has depth 90 and width 92, which is the same as length 86 of weir 82. Downcomers 64 and 80 define gaps 94 and 96 with the tray 36 therebelow. A space 98 is defined between downcomers 80 and 64. A connecting ring 100 with bolting bars 102 may be used to attach vertical plates 60 and 62 to the tray decks 38 and 40. Support rings may be welded or otherwise connected to tower shell 22 on the interior surface 24 thereof to support trays 34.

The width 76 and 92 of the downcomers 64 and 80 is as wide as will fit within the tower. The downcomers 64 and 80 may engage the inner surface 24 of tower shell 22, or may have a small space therebetween. Widths 76 and 92 is some embodiments are larger than the depths 74 and 90 and in one implementation area at least about 1.0-2.0 times wider than deep, and in one implementation at least about 1.5 times wider than deep. The width of the downcomers 64 and 80 is greater than the width of downcomers in other contact towers. The downcomers are closer to the center of the stripping tower 10, which allows the extended width of the downcomers 64 and 80. By increasing the width of the downcomers 64 and 80, the depth of the downcomers can be reduced while retaining high surface area for gas removal, which allows more trays to be used per tower height. For example, the typical distance between stages in a contact tower for removing H₂S from oil is about two feet. With the current implementation, trays can be spaced approximately one foot apart. In other words, in a tower with twenty total feet of space for trays, only ten trays could be used in existing towers, which the current design would allow twenty trays, which increases the efficiency of the towers.

The width of the downcomers 64 and 80 determines the surface area of gas-liquid interface. The greater the width, the greater the areas of gas liquid interface. By maximizing the gas liquid interface, the efficiency of the tower is increased. Weirs 66 and 82 have a length sufficient to span the distance of the tower shell wall. In other words, the length of weirs 66 and 82 is such that the weirs 66 and 82 will touch, or be proximate the inner surface of the tower shell 22 at both ends thereof. The length of weirs 66 and 82 is generally identical to the widths 76 and 92 of downcomers 64 and 80.

Trays 36 may comprise a tray deck 110 with straight outer edges 112 and 114 and curved connecting portions 116 and 118. Vertical plates 120 and 122 are connected to outer edges 112 and 114 respectively. Vertical plate 120 defines external downcomer 124 with lower edge 126 and has a depth 128 and a width 130. Width 130 is greater than depth 128 in some embodiments which maximizes the gas-liquid interface. Width 130 is such that it will extend to contact, or almost contact the inner surface 24 of tower shell 22 and may be at least about 1.0-2.0 times the depth 128, and may be at least about 1.5 times the depth 128 to maximize gas liquid interface area. Vertical plate 120 defines a weir 132 with a height 134 and a length 136, that is the same as width 130 of downcomer 124.

Vertical plate 122 defines external downcomer 140 with lower edge 142, a depth 144 and a width 146. Width 146 is greater than depth 144 in some embodiments which maximizes the gas-liquid interface. Width 146 is such that it will extend to contact, or almost contact the inner surface 24 of tower shell 22 and may be at least about 1.0 to 2.0 times the depth 144, and may be at least about 1.5 times the depth 144 to maximize gas liquid interface area. The geometric configuration of downcomers 124 and 140 is like that as described with reference to downcomers 64 and 80. Vertical plate 122 defines a weir 148 extending upward from straight edge 114 with height 150, which is generally identical to height 134 and has a length 152 that is identical to width 146 of downcomer 140. Gaps 154 and 156 are defined by the downcomers 124 and 140 and the stage 34 therebelow. Connecting rings 158 with bolting bars 160 may be used in the assembly of trays 36. Support rings may be welded to the inner surface of the tower shell 22 to support trays 36. Spaces 166 and 168 are defined between external downcomers 124 and 140 and the inner surface 24 of tower shell 22. Weirs 132 and 148 have a length sufficient to span the distance of the tower shell wall. In other words, the length of weirs 132 and 148 is such that the weirs 132 and 148 will touch, or will be proximate the inner surface of the tower shell 22 at both ends thereof.

Tray configurations 34 and 36 in first section 15 have chimneys 162 connected thereto and extending upwardly therefrom. In the described embodiment, three of trays 32 have chimneys, two of configuration 34 and one of configuration 36. Chimneys 162 have an open bottom 164 through which gas passes and serve to stabilize incoming crude oil and remove entrained gas before progressing to the bubble cap trays in second section 20. Chimneys 162 are shown as trapezoidal, but other geometric shapes may be used. Oil is delivered to stripping tower 10 from a crude oil source through inlet distribution tee 170 with outlet tubes 172 at the ends thereof.

Oil is delivered through outlet tubes 172 on the outside of false downcomers 50 and 52. Oil will flow beneath false downcomers 50 and 52 in gaps 54 and 56 and will flow over weirs 66 and 82, which have a smaller height than the height of the chimneys 162. False downcomers 50 and 52 serve as a buffer to provide initial degassing and to provide some buffer volume to smooth inconsistent flows at the uppermost tray. Chimneys 162 do not have a floor and allow gas released in the stages therebelow to flow upwardly therethrough. The chimneys 162 thus prevent gas buildup in fluid therebelow. In the described implementation, the cross-sectional area of the open space around the chimneys 162 is approximately equal to the cross-sectional area of the bubble cap area in a properly sized bubble cap stage in second section 20. The open planar surfaces 174 around chimney 162 on tray configuration 34 and planar surface 175 on tray configuration 36 allows liquid to pool before spilling over weirs 66 and 82 to increase residence time which allows the release of gas bubbles. The height of chimneys 162 should be sufficient to avoid fluid or foam from spilling over into the chimney 162. The chimney walls may be at an obtuse angle from plate decks 38 and 40 which may help smooth the fluid flow.

Second section 20 incorporates high cap density bubble cap trays 180 designed to increase the surface area for sweet gas interaction within the crude oil. Second section 20 optimizes mass transfer, allowing injected gas to capture and strip H₂S from the oil efficiently. High density bubble cap trays 180 in one embodiment comprise high density bubble cap tray configurations 182 and 184. Tray configurations 182 and 184 are like configurations 34 and 36, but instead of chimneys 162, trays 182 and 184 include gas contact devices, such as bubble caps 186. As a result, the same identifying numbers will be used for common features.

Thus, tray, or stage 182, has tray deck 38 with a downcomer 64 extending downward therefrom and a weir 66 extending upwardly therefrom. Tray deck 40 of tray configuration 182 has downcomer 80 extending downward therefrom and a weir 82 extending upwardly therefrom. Tray, or stage 184, has tray deck 110 with downcomers 124 and 140 and weirs 132 and 148. Tray decks 38 and 40 of tray 182 have bubble caps 186 thereon, as does tray deck 110 of tray 184.

Bubble caps 186 define a gas injection zone 200 and are spaced from weir 66 on tray deck 38 and are spaced the same distance from weir 82 on tray deck 40 of tray 182. Tray deck 38 of tray 182 has planar surface area 192 with no bubble caps 186 thereon adjacent weir 66. Planar surface area 192 comprises a buoyancy release zone 194, in that liquid will pool before spilling over weir 66 and will provide additional residence time for gas bubbles to be released from liquid. Likewise, tray deck 40 of tray 182 has planar surface area 196 with no bubble caps 186 thereon adjacent weir 82. Planar surface area 196 comprises a buoyancy release zone 198, in that liquid will pool before spilling over weir 82 and will provide additional residence time for gas bubbles to be released from liquid. Buoyancy release zones 194 and 198 comprise the buoyancy release zone 199 for the trays 182. Bubble caps 186 on tray deck 38 of tray 182 have little, or no space to the external downcomer 124 thereabove and as a result, the gas injection zone 200 on tray deck 38 of tray 182 is proximate the downcomer from the tray thereabove, which is the liquid inlet for the tray 182. Bubble caps 186 on tray deck 40 of tray 182 have little, or no space to the external downcomer 140 thereabove and as a result, the gas injection zone 201 on tray deck 40 of tray 182 is proximate the downcomer from the tray thereabove, which is the liquid inlet for the tray 182. Trays 182 in high density bubble cap section thus have a gas injection zone 203, which may be referred to as an active area, comprised of injection zones 200 and 201 in which gas is injected into the liquid, and a gas release zone, which may be referred to as a passive area, comprising planar surfaces 192 and 196 in which gas is released. The active area is about 40% to 60% of the combined active area and passive area, and may be about the same as the passive area.

Bubble caps 186 on tray 184 comprise a gas injection zone 204 and a buoyancy release zone 218 defined by a planar surface 208 in which no bubble caps exist. Bubble caps 186 are spaced from weirs 132 and 148 with planar surfaces 208 therebetween and are positioned proximate the downcomers 64 and 80 extending from the tray thereabove. The bubble caps 186 are thus positioned closer to the downcomers 64 and 80 from the tray thereabove than to weirs 132 and 148. Thus, the bubble caps 186 on tray 184, and the gas injection zone 204 is proximate the liquid entry for the trays 184. Trays 182 and 184 have both a gas injection zone in which gas is injected into liquid, and a gas release zone in which gas is released. The density of the bubble caps in the active area in second section 20 is greater than the density in existing towers. The bubble cap tray design allows for a lower gas flow rate to liquid flow rate than conventional stripping towers.

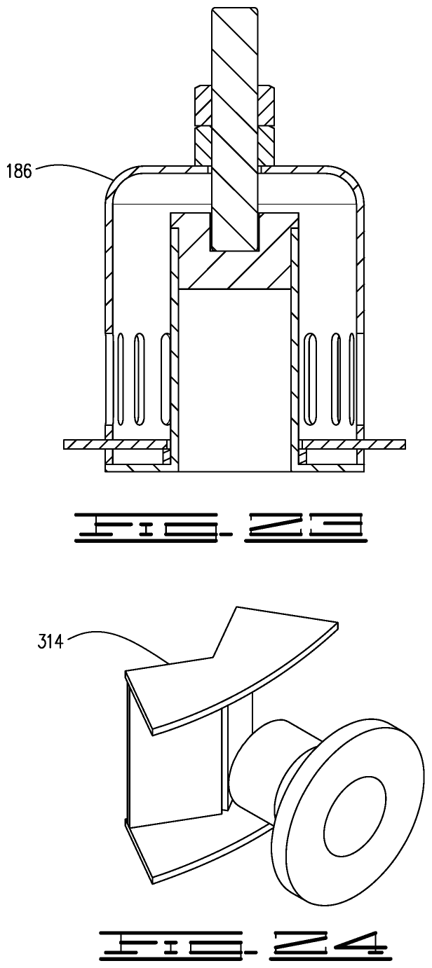

Optimized mass transfer results from the bubble cap density per active area and their strategic placement within the stage. Bubble caps 186 are positioned near the entry point of each of trays 182 and 184 to immediately mix gas with the incoming oil while allowing the remaining oil to degas. Bubble caps 186 on trays 182 are positioned to maximize the planar surface areas 138 and 140 near weirs 66 and 82. In other words, the bubble caps 186 are positioned nearer to the downcomers from the tray thereabove than to the weirs 66 and 82. The bubble caps 186 on trays 184 are likewise positioned to maximize the planar surfaces 208 to aid in increasing the defoaming and degassing efficiency. Bubble caps 186 are shown cross in FIG. 23.

Third section 25 transitions to reduced cap density bubble cap trays, shifting focus from gas absorption (by injecting gas into the liquid) to enhanced oil degassing. The active area on trays in the third section 25 is less than the active area of trays in the second section 25 Reduced density bubble cap trays 230 comprise first and second configurations 232 and 234, which are identical to high density bubble cap tray configurations 182 and 184, except for the reduction in the number of bubble caps. The reduction in bubble caps 186 is designed to further increase the planar surface area near the outlet weirs of both tray configurations 232 and 234, which provides for a wide range of flow rates and an efficient distribution of natural gas. By reducing cap density per active area, the system ensures a controlled separation process that minimizes carryover and improves oil quality. Optimized mass transfer results from the cap density per active area and their strategic placement within the stage. Bubble caps 186 are positioned near the entry point of each stage to immediately mix gas with the incoming oil while allowing the remaining oil to degas.

Thus, tray, or stage 232 has tray deck 38 with a downcomer 64 extending downward therefrom and a weir 66 extending upwardly therefrom. Tray deck 40 of tray configuration 232 has downcomer 80 extending downward therefrom and a weir 82 extending upwardly therefrom. Tray, or stage 234 has tray deck 110 with downcomers 124 and 140 and weirs 132 and 148. Tray decks 38 and 40 of tray 232 have bubble caps 186 thereon, as does tray deck 110 of tray 234. The density of bubble caps 186 on tray 232 and 234 is less than the density of trays 182 and 184.

Bubble caps 186 define a gas injection zone 236 on tray deck 38 and are spaced from weir 66 on tray deck 38 and are spaced the same distance from weir 82 on tray deck 40 of tray 232. Tray deck 38 of tray 232 has planar surface area 240 with no bubble caps 186 thereon adjacent weir 66. Planar surface area 240 comprises a buoyancy release area 241, in that liquid will pool before spilling over weir 66, and will provide additional residence time for gas bubbles to be released from liquid. Likewise, tray deck 40 of tray 232 has planar surface area 242 with no bubble caps 186 thereon adjacent weir 82. Planar surface area 242 comprises a buoyancy release area 244, in that liquid will pool before spilling over weir 82 and will provide additional residence time for gas bubbles to be released from liquid. Tray deck 40 of tray 232 has gas injection zone 246. Planar surface areas 240 and 242 are generally the same and have a larger area than planar surfaces 192 and 196 on tray 182. Bubble caps 186 on tray deck 38 of tray 232 have little, or no space to the external downcomer 124 thereabove and as a result, the gas injection zone on tray deck 38 of tray 232 is proximate the downcomer from the tray thereabove, which is the liquid inlet for the tray 232. Bubble caps 186 on tray deck 40 of tray 232 have little, or no space to the external downcomer 140 thereabove and as a result, the gas injection zone on tray deck 40 of tray 232 is proximate the downcomer from the tray thereabove, which is the liquid inlet for the tray 232. Trays 232 in low density bubble cap section thus have a gas injection zone comprising gas injection zones 236 and 246 in which gas is injected into the liquid, and a gas release zone, comprising planar surfaces 242 and 244 is which gas is released.

Bubble caps 186 on tray 234 comprise a gas injection zone 250 and a buoyancy release zone 252 defined by a planar surface 254 in which no bubble caps exist. Bubble caps 186 are spaced from weirs 132 and 148 with planar surfaces 254 therebetween and are positioned proximate the downcomers 64 and 80 extending from the tray thereabove. Bubble caps 186 are thus positioned closer to the downcomers 64 and 80 from the tray thereabove than to weirs 132 and 148. Thus, the bubble caps 186 on tray 234, and the gas injection zone 250 is proximate the liquid entry for the trays 234. Trays 234 have both a gas injection zone in which gas is injected into liquid, and a gas release zone in which gas is released. Thus, the stripping tower 10 comprises a plurality of vertically spaced apart trays having bubble caps thereon, which includes a first plurality of trays having a first density of bubble caps, and a second plurality of trays having a second density of bubble caps. The active area on trays in the third section 25 is less than the active area on trays in the second section.

Fourth section 30 comprises a final tray 260 which is configured like tray 234 in third stage 25 and thus has bubble caps 186 positioned as described above. Extended downcomers 262 and 264 extending downwardly from tray 260 and weirs 266 which are identical to weirs 132 and 148 extend upwardly therefrom. Fourth section 30 has a seal pad 269 which is submerged, and which plays a role in preventing, or at least limiting re-entrainment of stripped H₂S gas. Seal pad 269 is submerged in an oil bath in the bottom of stripping tower 10, which is created by the predetermined set points for oil levels in the tower as explained below.

Extended downcomers 262 and 264 are designed to slow oil flow. Downcomers 262 and 264 direct oil to the sides of the tower, so that the flow of oil is between the inner surface 24 of the stripping tower 10 and an exterior of downcomers 262 and 264, which mitigates splashing and contains the froth produced by the splashing from the oil bath. The seal pad 269 redirects fluid velocity from extended downcomer upward towards the liquid surface and away from the liquid outlet allowing for additional degassing before the fluid exits the stripping tower 10. By redirecting the liquid as shown by the arrows, the gas flow path to the exit is extended which provides increased opportunity for gas bubbles to combine. Because the liquid flows upwardly in the seal pad 269, the motion of escaped gas is directed upwardly toward the gas liquid interface and toward the gas outlet. In addition, residence time of the liquid in the stripping tower 10 is increased. The additional residence time at the seal pad enables further disengagement of dissolved gas before the liquid leaves the stripping tower 10. Gas injection inlet 12 is positioned in fourth section 30 through which gas is injected into stripping tower 10. Seal pad 269 is comprised of first and second curved segments 270 and 272, with legs 274 and 276 extending upwardly from the straight edges of segments 270 and 272 respectively. False downcomers 262 and 264 have lower edges 278 and 280 and extend downwardly past the upper edges 282 and 284 of legs 274 and 278 into spaces 286 and 288 between legs 274 and 276 and the tower shell 24. Spaces 290 and 292 are defined between false downcomers 262 and 264 and the inner surface 24 of tower shell 22.

A plurality of sensors, including a high level sensor 300, an intermediate high level sensor 302, a low intermediate level sensor 304 and a low level sensor 306 will sense the liquid level in the stripping tower 10. Valve, or liquid level controller 308 will receive signals for the sensors and will open when to release liquid when the liquid level reaches the low level predetermined levels in the tower. Liquid level controller 308 regulates the release of fluid through liquid outlet 30 and is configured so that fluid is not discharged until the liquid level reaches the set point corresponding to the liquid level controller 308. When the level rises above the set point, which is at the intermediate high level sensor 302 the liquid level controller opens the corresponding valve 308 to permit flow; when the level drops below the desired set point for the release of liquids, which is the intermediate low level sensor 304 the valve closes, ensuring a consistent seal and stable liquid retention time. Thus, upper and lower set points for the oil level of the oil bath are established, and determinations are made when the crude oil reaches the upper set point and when the oil level reaches the lower set point. Oil is released from the stripping tower when the oil reaches the upper set point; and is prevented from exiting the tower when the oil level reaches the lower set point. The extended downcomers 262 and 264 and seal pad 269 create a holding chamber in which liquid is retained prior to exiting the tower, which increases residence time to allow the continued release of H₂S gas from the liquid.

Other features incus a mist eliminator through which exiting gas passes prior to leaving sour gas outlet 14. Mist eliminators are known in the art. A vortex breaker 312 is positioned at the lower end of the stripping tower 10 to produce even flow out of outlet. The vortex breaker 312 prevents induced swirling flow (similar to a whirlpool) that can develop a gas column (vortex) from forming and enabling gas to exit out of the stripping tower 10 through the liquid outlet. A gas inlet baffle 314 is positioned at sweet gas inlet 12. The gas inlet baffle 314 spreads the gas evenly in the chamber and ensures that gas will not form a preferential flow path through the trays.

In operation, crude oil enters the stripping tower 10 through inlet distribution tee 170 and undergoes a staged degassing process. Sweet natural gas is injected at controlled rates through gas inlet 12 to enhance stripping efficiency. The progressive transition from high cap density trays 180 to reduced cap density trays 230 ensures maximum H₂S removal before the oil reaches the extended downcomers 262 and 264. The extended downcomers 262 and 264 direct oil flow into a sealed bath, preventing vapor re-entrainment and stabilizing the crude oil before it is transferred for further processing or transport. The stripping tower 10 in the described implementation is a double-pass tower. The system is designed to operate at varying flow rates, with both single-pass and double-pass tray configurations available depending on barrels of oil per day throughput. Mounting the stripping tower 10 on a skid enables rapid and straightforward placement while also allowing for modular expansion by adding multiple towers in parallel to maintain peak efficiency per stripping tower.

Stripping tower 10 is designed to be adaptable to different process conditions utilizing pressure controls. By optimizing tray density, residence time, and gas interaction, the stripping tower 10 provides a superior solution for H₂S removal by controlling pressure for various situations. The design and configuration of the stripping tower 10 provides a greater turndown than is achievable in current towers. “Turndown” as is known in the art, refers to the operating capacity at which the tower can function effectively while maintaining desired mass transfer and separation. Typically H₂S removal towers are used in the downstream oil and gas industry, where liquid and gas flow rates a relatively controlled. The towers in those cases are designed for a specific flow rate, and have a low turndown, and likewise have a low high-end capacity. In other words the towers do not allow for much, if any flow higher than the designed flow rate before flooding out will occur. The features of the stripping tower 10 that contribute to a high turndown and increased high-end capacity include, but are not limited to the configuration of downcomers 64, 80, 132 and 140, extended final stage downcomers 260 and 262 with a significantly greater depth than the depth of other downcomers 64, 80, 132 and 140, trays with both a gas injection area and a gas release area, and a seal pad 269 that reverses the liquid flow prior to exit of the liquid to direct gas upwardly, and also creates a holding chamber in which liquid is retained prior to exit from the stripping tower 10. For example, a tower designed for an efficiency of 90% H₂S removal of three thousand barrel per day liquid flow with the features disclosed herein will have a turndown of up to around 40%, and a high end capacity of as much as 20% and will maintain 90% efficiency. In other words, a stripping tower 10 designed for a three-thousand barrel a day flow rate, will be 90% efficient at a low end flow rate of eighteen hundred barrels per day, and at a high end of thirty six hundred barrels per day. As previously noted, flow rates for sweet gas introduced into the tower gas can be calculated with models, for example HySys, using real gas analysis and liquid analysis data In addition to the features noted, the stripping tower 10 provides for an increased density of trays as a result of the configuration of the downcomers 64, 80, 132 and 140 which allow for closer spacing of trays.

A single pass embodiment of a stripping tower 320 is shown in FIGS. 25-29. FIG. 25 shows a single pass tower 320 with a first, or initial degassing zone 322, a second, high density bubble cap tray section 324, a third, or low density bubble cap tray section 326 and a fourth, or extended downcomer and seal pad section 328. Tower 320 has a plurality of trays 330, which in some cases may be referred to with a letter subscript for ease of identification. Trays 330 are rotated 180 degrees from the adjacent tray 330 thereabove and therebelow. Trays 330 may include a support ring 400 and bolting bars 402 and may be supported by mounting rings welded to the interior of the tower 300.

A feed pipe 332 with an opening 334 therein delivers liquid, for example crude oil, onto the uppermost tray 330a in the first, or initial degassing section 322 past a false downcomer 325. A gap 327 is defined between false downcomer 325 and tray 330a. Trays 330 comprise a tray deck 340 with a vertical plate 342 connected to a straight edge 344 thereof. Tray deck 340 has a curved edge 346. Vertical plate 342 defines a downcomer 348 with a lower edge 350 and a depth 352. Downcomer 348 has a width 354 that extends to the inner surface of the tower shell and is greater than the depth 352 in some embodiments. In one embodiment, width 354 is at least about 1.0-2.0 times the depth and may be at least about 1.5 times the depth. As described, the shape of the downcomer 348 provides for the maximum surface area while at the same time allowing for more trays to be used in a tower than was previously known.

Vertical plate 342 defines a weir 356 with a height 360 and with length 358 that extends sufficiently so that the ends of weir 356, contact, or are proximate the inner surface of the tower shell. Length 358 is the same as width 354 of downcomer 348. Trays 330a-330c may have a chimney 362. Chimney 362 is depicted as square, but may be other shapes. Chimney 362 operates the same as chimney 162. A gap 364 is defined between the downcomer 348 and the tray 330 therebelow.

Trays 330d-330j in high density bubble cap section 324 have a plurality of bubble caps 186 positioned on the tray decks 340 thereof in a gas injection zone 366. Bubble caps 186 are spaced from weir 356 to define a planar surface 370 which has no bubble cap or other contact device. Planar surface 370 defines a buoyancy release zone 372 in which no bubble caps exist to allow the release of gas prior to the time liquid spills over weir 356. Thus trays 330d-330j have a gas injection zone 366 and a gas release zone 372. Bubble caps 186, and thus gas injection zones 366 have little, if any space to the downcomer 348 extending from the tray thereabove, so that the gas injection zone is positioned proximate the liquid entry for each of the trays 330. The active area of trays in section 324 may be about 40-605 of the combined passive and active area, and in one implementation may be about the same as the passive area.

Trays 330k-330y in reduced density bubble cap section 326 have a plurality of bubble caps 186 positioned on the tray decks 340 thereof in a gas injection zone 380. Gas injection zone 380 is smaller in area than gas inject zone 336. Bubble caps 186 are spaced from weir 326 on the trays 330 in third zone 326 a planar surface 384 which has no bubble cap or other contact device. Planar surface 384, which defines a greater surface area than planar surface 370 defines a buoyancy release zone 386 in which no bubble caps exist to allow the release of gas prior to the time liquid spills over weir 356. Thus trays 330k-330y have a gas injection zone 380 and a gas release zone 386. Bubble caps 186, and thus gas injection zones 380 have little, if any space to the downcomer 348 extending from the tray thereabove, so that the gas injection zone is positioned proximate the liquid entry for each of the trays 330. The active areas on the trays in third section 326 is less than the active area on the trays in section 324.

Tower 300 has extended downcomer 390 and submerged seal pad 392. Extended downcomer has a depth 391 that is greater than the depth 352 of downcomers 348. Submerged seal pad 392 comprises a curved segment 394 with a leg 396 extending upwardly from the straight edge of curved segment 394. Extended downcomer 390 extends into space 398 defined by leg 396 and the wall of the tower 300.

Tower 300 has a sweet gas inlet 12, a sour gas outlet 14, a crude oil inlet 16 and a crude oil outlet. The operation of tower 300 is like that described with respect to the double pass tower 10. Crude oil is delivered into first section 322 and flows into second, high density bubble cap section 324. Each tray 330 is rotated one-hundred eighty degree from the adjacent tray 330 thereabove and therebelow. Liquid flows into tower 300 over false downcomer 325 and through gap 327 onto tray deck 332 of tray 330a, over weir 356 onto the tray deck 340 of tray 330b therebelow. Liquid flows through the gap 364 between the downcomer 348 of the tray 330a and the tray deck 340 of tray 330b therebelow. The process continues as liquid flows through high density bubble cap section 324 and low cap density section 326. Gas is injected into the liquid through bubble caps 186, and gas is released from the liquid in the release zones on the trays 330, in addition to the release that occurs as the liquid flows, and as it is reverses direction and is held in the seal pad section 328. An oil bath 410 with an oil level 412 is created by the flowing oil along with the high and low level set points. Sensors will sense the level of liquid in seal pad section 308 and will allow liquid to flow out of the tower 300 when the liquid level is at the high level set point and will prevent flow when liquid reaches a low level set point.

What is claimed is:

1. A stripping tower for removing hydrogen sulfide (H₂S) from crude oil flowing downwardly therein, comprising:
an injection port for injecting sweet gas into the stripping tower;
a plurality of vertically spaced apart trays having gas-liquid contact devices thereon;
a downcomer extending downwardly a first depth from each tray, the downcomer and the tray immediately therebelow having a gap therebetween for the flow of crude oil therethrough;
an extended downcomer positioned below a lowermost tray of the vertically spaced apart trays, the extended downcomer extending downward from the lowermost tray a second depth that is greater than the first depth; and
a seal pad positioned beneath the extended downcomer, wherein the seal pad reverses the direction of flow of the crude oil from a downward direction to an upward direction toward an oil level of an oil bath in the stripping tower prior to the time the crude oil exits the stripping tower.

2. The stripping tower of claim 1, wherein the gas-liquid contact devices are selected from the group consisting of bubble caps, fixed valves and float valves.

3. The stripping tower of claim 2, wherein the plurality of vertically spaced apart trays having bubble caps thereon comprise a first plurality of trays having a first plurality of bubble caps, and a second plurality of trays having a second plurality of bubble caps, wherein the first plurality is greater than the second plurality.

4. The stripping tower of claim 1, wherein the extended downcomer extends downward below the oil level of the oil bath in the stripping tower.

5. The stripping tower of claim 1, wherein the width of the downcomers on the trays above the lowermost tray is at least about one and one-half times the first depth.

6. The stripping tower of claim 1, wherein sweet gas is injected at a rate of about 0.01 to about 0.08 MCF/BO.

7. The stripping tower of claim 1, further comprising:
a crude oil inlet; and
a flat tray positioned above the plurality of vertically spaced apart trays having gas-liquid contact devices thereon and positioned below the oil inlet for receiving oil from the oil inlet, wherein the flat tray does not have any gas-liquid contact devices thereon.

8. A method of stripping hydrogen sulfide (H₂S) from crude oil, comprising:
introducing crude oil with H₂S into a stripping tower having a plurality of vertically spaced trays with gas-liquid contact devices thereon;
flowing the crude oil downwardly through the stripping tower to flow over a surface of the trays;
introducing sweet natural gas into the stripping tower so that it moves counter currently to the downward flow of the crude oil in the tower;
injecting the sweet natural gas into the crude oil with the gas-liquid contact devices as the crude oil flows downward from tray to tray through the stripping tower;
directing the crude oil past an extended downcomer in the stripping tower; and
reversing the flow of the crude oil in the tower below a lower edge of the extended downcomer prior to releasing the crude oil through a crude oil outlet.

9. The method of claim 8, wherein the plurality of vertically spaced trays with gas-liquid contact devices thereon comprise a plurality of first trays with a first plurality of gas-liquid contact devices and a plurality of second trays with a second plurality of gas-liquid contact devices, the first plurality being greater than the second plurality, the method further comprising flowing the crude oil over the first trays and subsequently flowing the crude oil over the second trays.

10. The method of claim 9, wherein the gas contact devices comprise bubble caps.

11. The method of claim 8, comprising injecting sweet natural gas at a controlled rate of about 0.01 to about 0.08 MCF/BO.

12. The method of claim 8, further comprising creating an oil bath in the bottom of the tower to increase the residence time of the oil in the tower.

13. The method of claim 12, wherein the liquid bath has an oil level, and wherein the extended downcomer extends below the oil level.

14. The method of claim 13, further comprising:
establishing upper and lower set points for the oil level of the oil bath;
determining when the crude oil reaches the upper set point;
determining when the oil level reaches the lower set point;
releasing oil from the stripping tower when the oil reaches the upper set point; and
preventing oil from exiting the tower when the oil level reaches the lower set point.

15. A stripping tower for removing H₂S from crude oil comprising:
a crude oil inlet;
a sweet gas inlet;
a crude oil outlet;
a plurality of vertically spaced trays with gas-liquid contact devices thereon over which the crude oil flows, wherein sweet gas is injected into the crude oil through the gas-liquid contact devices; and
a seal pad that reverses the direction of the flow of the crude oil from a downward direction to an upward direction before the crude oil passes out of the stripping tower through the crude oil outlet.

16. The stripping tower of claim 15, wherein the plurality of vertically spaced trays comprises:
a first set of trays with a first plurality of gas-liquid contact devices; and
a second set of trays with a second plurality of gas-liquid contact devices, wherein the first plurality is greater than the second plurality.

17. The stripping tower of claim 16, wherein the plurality of vertically spaced trays have downcomers extending therefrom, and wherein the downcomers have a width greater than a depth of the downcomers.

18. The stripping tower of claim 16, further comprising an extended downcomer connected to and extending downward from a lowermost tray of the plurality of trays, wherein the extended downcomer extends into an oil bath at the bottom of the stripping tower.

19. The stripping tower of claim 18, wherein the crude oil flows downward past the extended downcomer and reverses direction around a bottom edge of the extended downcomer.

20. The stripping tower of claim 18, wherein the stripping tower has two extended downcomers.
